(19) United States
(12) Patent Application Publication
(10) Pub. No.: US 2020/0165851 A1
(43) Pub. Date: May 28, 2020

(54) ACTIVE PEDESTRIAN HOOD HINGE WITH INTEGRATED LATCH ASSEMBLY

(71) Applicant: Magna Closures Inc., Newmarket (CA)

(72) Inventors: Stefan PAGE, Wupperta (DE); Stephan HOLSCHBACH, Wuppertal (DE); Thomas WOOD, Midland (CA)

(21) Appl. No.: 16/713,333

(22) Filed: Dec. 13, 2019

Related U.S. Application Data
(63) Continuation-in-part of application No. 16/697,547, filed on Nov. 27, 2019.
(60) Provisional application No. 62/771,640, filed on Nov. 27, 2018.
(60) Provisional application No. 62/779,166, filed on Dec. 13, 2018.

(51) Int. Cl. E05D 11/10; B60R 21/38; E05D 3/14

(52) U.S. Cl. CPC E05D 11/1007; B60R 21/38; B60R 2021/0004; E05D 11/1085; E05D 3/145

(57) ABSTRACT

An active hinge including a hood bracket for attachment to a vehicle hood and a body bracket for attachment to a vehicle body. A deploy bracket is pivotally attached to the hood bracket and the body bracket. The hood bracket is pivotable relative to the deploy bracket between a non-deployed position and a deployed position. At least one link interconnects, and is pivotally connected to the deploy bracket and the body bracket. A pawl is pivotally mounted to one of the hood bracket, the body bracket, the deploy bracket, and the at least one link. A bolt for engagement by the pawl is connected to another of the hood bracket, the body bracket, the deploy bracket, and the at least one link. An actuator is provided for disengaging the pawl from the bolt to allow the deploy bracket to move relative to the hood bracket and the body bracket.

### CROSS REFERENCE TO RELATED APPLICATIONS

This patent application is a Continuation-In-Part of U.S. patent application Ser. No. 16/697,547, filed Nov. 27, 2019, which claims the benefit and priority of U.S. Provisional Patent Application Ser. No. 62/771,640, filed Nov. 27, 2018 and U.S. Provisional Patent Application Ser. No. 62/779,166, filed Dec. 13, 2018. The entire disclosures of the above applications are incorporated herein by reference.

### FIELD OF THE INVENTION

The present disclosure relates generally to pedestrian protection systems for motor vehicles of the type having a deployable hood assembly equipped with active hinges. More particularly, the present disclosure is directed to an active hinge for use with a deployable hood assembly and which has a pawl and bolt engaged by the pawl for maintaining the active hinge in a deployed position until an actuator releases the pawl from the bolt.

### BACKGROUND OF THE INVENTION

This section provides background information related to the present disclosure which is not necessarily prior art.

In recent years, a great deal of emphasis has been directed to development of pedestrian protection systems for use in motor vehicles in an effort to reduce the likelihood or severity of injuries caused during a collision between a pedestrian and a motor vehicle. One such area of development has been directed to equipping the motor vehicle with a hood assembly capable of absorbing impact forces.

A “passive” pedestrian protection system associated with the hood assembly includes providing a pocket of under-hood crush space between the hood and the components within the vehicle's engine compartment. This crush space is configured to reduce the chance of bodily impact with the components within the engine component and, more particularly, to provide an impact absorbing feature. However, the use of low profile hoods in modern motor vehicles for improved aesthetics and aerodynamics, in combination with smaller engine compartments, limits the available crush space.

As an alternative, an “active” pedestrian protection system associated with the vehicle's hood assembly provides a “deployable” hood that is configured to raise a rear portion of the latched hood to create the additional under-hood crush space. This deployable hood feature is activated in response to detection of a pedestrian collision with the front end of the motor vehicle. Typically, a pair of active hinges are incorporated into the hood assembly. Each active hinge includes a pivot linkage interconnecting the hood to the vehicle body and an actuator that is operable to forcibly move the pivot linkage for causing the hood to move from a non-deployed position to a deployed position in response to detection of the pedestrian impact. Examples of active hinges that provide this functionality are disclosed in commonly-owned U.S. Pat. No. 8,544,590 and U.S. Publication No. 2014/0182962.

There remains a need for further improvements to such active hinges.

### SUMMARY OF THE INVENTION

This section provides a general summary of the disclosure and is not intended to be interpreted as a comprehensive listing of its full scope or of all of its objects, aspects, features and/or advantages.

It is an aspect of the present disclosure to provide an active hinge that is simple in design, uses few components, and is inexpensive to manufacture and incorporate into vehicles.

It is another aspect of the present disclosure to provide an active hinge that requires a small stroke of an actuator to rotate a pawl from a locked position to an unlocked position to allow at least two of a body bracket, a hood bracket and a deploy bracket to rotate relative to one another.

It is another aspect of the present disclosure to provide a pawl design that is easy to manufacture and does not require fine blanking of components.

In accordance with these and other aspects of the present disclosure, an active hinge is provided. The active hinge includes a hood bracket for attachment to a vehicle hood, a body bracket for attachment to a vehicle body 7, and a deploy bracket pivotally attached to the hood bracket and the body bracket. The hood bracket is pivotable relative to the deploy bracket between a non-deployed position and a deployed position. At least one link interconnects and is pivotally connected to the deploy bracket and the body bracket. A pawl is pivotally mounted to one of the hood bracket, the body bracket, the deploy bracket, and the at least one link. The pawl is configured to engage a bolt. The bolt is connected to another of the hood bracket, the body bracket, the deploy bracket, and the at least one link. An actuator is configured to selectively pivot the pawl for disengaging the pawl from the bolt to allow at least one of the hood bracket, the body bracket and the at least one link to move relative to another of the at least one of the hood bracket, the body bracket and the at least one link to allow the hood bracket to move from a non-deployed position to a deployed position.

The arrangement of the subject active hinge requires little energy to activate the actuator and rotate the pawl to allow the hood bracket to move to the deployed position. More particularly, the subject active hinge requires less energy than prior art active hinge systems which typically require locking devices to be destroyed by an actuator in order to provide movement of a deploy bracket. Furthermore, the position of the pawl next to the actuator of the subject active hinge requires a small actuator stroke to provide rotation of the pawl to allow the hood bracket to move into the deployed position.

According to another aspect of the disclosure, the pawl defines a hook portion that defines a pocket that receives the bolt, and the bolt tapers radially outwardly for fixing the pawl to the bolt to hold at least two of the hood bracket, the body bracket and the deploy bracket together. Accordingly, the active hinge does not require a spring to hold the pawl in a locked position, and the pawl holds the components of the active hinge in tension, thus preventing noise, vibrations and rattling.

A method for assembling an active hinge is also provided. The method includes providing a hood bracket for attachment to a vehicle hood and providing a body bracket for attachment to a vehicle body. The method also includes pivotally connecting a deploy bracket to the hood bracket and pivotally connecting the deploy bracket to the body bracket. The method also includes pivotally connecting a link to the deploy bracket and pivotally connecting the link to the body bracket. The method also includes pivotally connecting a pawl to one of the hood bracket, the body bracket, the deploy bracket, and the at least one link, wherein the pawl defines a pocket. The method also includes positioning a bolt against one of the hood bracket, the body bracket, the deploy bracket, and the at least one link, with the bolt received by the pocket of the pawl. The method also includes applying an axial compressive force to the bolt to radially expand the safety bolt and eliminate radial gaps between the safety bolt and the pawl to inhibit movement between the at least one of the hood bracket, the body bracket, the deploy bracket and the at least one link which the pawl is connected to and the at least one of the hood bracket, the body bracket, the deploy bracket and the at least one link which the bolt is positioned against.

Compressing/shaping the bolt in this manner eliminates the need for a spring to hold the pawl in a locked position, and the pawl holds the components of the active hinge in tension, thus preventing noise, vibrations and rattling.

An active hinge is also provided, the active hinge including a hood bracket for attachment to a vehicle hood, a body bracket for attachment to a vehicle body, a locking mechanism coupled between the hood bracket and the body bracket, the locking mechanism comprising an unlocked state for allowing the hood bracket to move away from the body bracket and a locked state for preventing the hood bracket to move away from the body bracket, the locking mechanism further comprising a bolt in a tensed relationship with the locking mechanism for maintaining the locking mechanism in the locked state, and an actuator for selectively actuating the locking mechanism for transitioning the locking mechanism from the locked state to the unlocked state, such that selectively actuating the locking mechanism relieves the tensed relationship to allow the locking mechanism to transition from the locked state to the unlocked state.

In accordance with a related aspect, when the locking mechanism of the active hinge is in the unlocked state the hood bracket is allowed to move away from the body bracket by the actuator.

In accordance with a related aspect, the locking mechanism includes a moveable lever configured for movement between a locked position and an unlocked position, the moveable lever comprising an engagement surface for tensed engagement with the bolt when the moveable lever is in the locked position to establish the locking state of the locking mechanism.

In accordance with a related aspect, the tensed engagement of the bolt with the engagement surface of the moveable lever prevents a vibration of the moveable lever against the bolt.

In accordance with a related aspect, the locking mechanism includes a pawl configured for pivotal movement about a pivot axis between a locked position and an unlocked position, the pawl comprising an engagement surface for engagement with the bolt when the pawl is in the locked position to establish the locking state of the locking mechanism.

In accordance with a related aspect, the tensed relationship is established by a portion of the bolt exerting a force against the engagement surface of the pawl biasing the pawl away from the pivot axis of the pawl.

In accordance with a related aspect, the tensed relationship establishes a coefficient of friction between the bolt and the engagement surface of the pawl.

In accordance with a related aspect, the pawl has a hook portion having the engagement surface defining a pocket receiving the bolt.

In accordance with a related aspect, at least a portion of the bolt is in a path blocking a motion of the hook when the pawl is in the locked position.

In accordance with a related aspect, selectively actuating the locking mechanism causes the hook to bypass the portion of the bolt blocking the motion of the hook.

In accordance with a related aspect, the hook bypassing the portion of the bolt blocking the motion of the hook causes a localized deformation of at least one of the bolt and the pawl.

In accordance with a related aspect, the locking mechanism is maintained in the locked state without use of a spring.

In accordance with a related aspect, the tensed relationship is established when the pawl is in the locked position and a portion of the bolt is in an expanded state relative to the other portion of the bolt.

In accordance with a related aspect, the active hinge may further include at least one of a deploy bracket pivotally attached to the hood bracket and the body bracket, the hood bracket being pivotable relative to the deploy bracket between a non-deployed position and a deployed position, and at least one link interconnecting and pivotally connected to the deploy bracket and the body bracket, such that an additional tensed relationship is established between the bolt and at least one of the a deploy bracket and the at least one link.

In accordance with yet another aspect of the present disclosure, there is provided an active hinge including a hood bracket for attachment to a vehicle hood, a body bracket for attachment to a vehicle body, a deploy bracket pivotally attached between the hood bracket and the body bracket, the hood bracket being moveable relative to the body bracket between a non-deployed position and a deployed position, a locking hook pivotally mounted to one of the body bracket and the deploy bracket, and an engagement feature for engagement by the locking hook, the engagement feature provided on another one of the body bracket and the deploy bracket, and an actuator for selectively pivoting the locking hook for engaging the locking hook with the engagement feature to prevent the deploy bracket from moving relative to the body bracket and for moving the hood bracket from the non-deployed position to the deployed position.

In accordance with another related aspect of the present disclosure, there is provided a method for assembling an active hinge, the method including the steps of providing a hood bracket for attachment to a vehicle hood, providing a body bracket for attachment to a vehicle body, pivotally connecting a deploy bracket between the hood bracket and the body bracket, pivotally connecting a locking hook to one of the body bracket and the deploy bracket, providing an engagement feature on another one of the body bracket and the deploy bracket, and configuring the locking hook for pivoting into engagement with the engagement feature to prevent the deploy bracket from moving relative to the body bracket and for pivoting out of engagement with the engagement feature to permit the deploy bracket to move relative to the body bracket.

Further areas of applicability will become apparent from the description provided. The description and specific examples in this summary are intended for purposes of illustration only and are not intended to limit the scope of the present disclosure.

### DRAWINGS

The drawings described herein are for illustrative purposes only of selected embodiments and not all possible implementations thereof such that the drawings are not intended to limit the scope of the present disclosure.

FIG. 1 is a first side front perspective view of a vehicle hood assembly having a hood and an active hinge constructed in accordance with the present disclosure and showing the vehicle hood assembly located in a normal-closed position with the hood in a latched condition and the active hinge in a non-deployed condition;

FIG. 2 is a similar first side perspective view as FIG. 1, now showing the vehicle hood assembly in a deployed position with the hood maintained in its latched condition and its rear edge segment raised and with the active hinge in a deployed condition;

FIG. 3 is a first side view of a first example embodiment of an active hinge illustrating a pawl in a locked position and a hood bracket in a non-deployed position;

FIG. 4 is a second side view of the first example embodiment of an active hinge illustrating the pawl in the locked position and the hood bracket in a non-deployed position;

FIG. 5 is a magnified first side view of a hood bracket and deploy bracket of the first example embodiment of an active hinge illustrating the pawl in the locked position and the hood bracket in a non-deployed position, and further illustrating an actuator for rotating the pawl;

FIG. 6 is a front perspective view of the first example embodiment of an active hinge illustrating the pawl in the locked position and the hood bracket in a non-deployed position;

FIG. 7 is a magnified view of the pawl and a bolt of FIG. 6;

FIG. 7A is a side cross-sectional view of the bolt of FIG. 6;

FIG. 8 is a magnified view of the hood bracket, deploy bracket, pawl and bolt of FIG. 1, illustrating rotation of the pawl from a locked position to an unlocked position in response to engagement by an actuator;

FIG. 9 is a first side view of the pawl of the first example embodiment of an active hinge;

FIG. 10A is a side schematic view illustrating a safety bolt positioned against a bracket and received by a pocket of a pawl prior to applying a compressive axial force to the safety bolt;

FIG. 10B is a side schematic view illustrating the safety bolt of FIG. 10A after a compressive axial force has been applied to the safety bolt;

FIG. 10C is a side schematic view illustrating the safety bolt of FIG. 10A after a compressive axial force has been applied to the safety bolt;

FIG. 11 is a flow diagram illustrating a method of aligning a safety bolt relative to a bracket and pawl and applying a compressive force to the safety bolt;

FIG. 12 is a first side perspective view of a second example embodiment of an active hinge illustrating a pawl in a locked position and a hood bracket in a non-deployed position;

FIG. 13 is a first side perspective view of the second example embodiment of an active hinge illustrating the pawl in the locked position and the hood bracket in the non-deployed position, and not including the actuator;

FIG. 14 is a magnified view of the pawl and a bolt of FIG. 11;

FIG. 15 is a first side perspective view of the second example embodiment of an active hinge illustrating the pawl in an locked position and the hood bracket in the non-deployed position;

FIG. 16 is a first side perspective view of the second example embodiment of an active hinge illustrating the pawl in a locked position and the hood bracket in the non-deployed position, and not including the actuator;

FIG. 17 is a first side perspective view of the second example embodiment of an active hinge illustrating the pawl in an locked position and the hood bracket in a deployed position;

FIG. 18 is a first side perspective view of the second example embodiment of an active hinge illustrating the pawl in an locked position and the hood bracket in a deployed position, and not including the actuator;

FIG. 19 is a first side view of a third example embodiment of a pawl having an extended hook portion and contact face; and

FIG. 20 is another first side view of the third example embodiment of a pawl having an extended hook portion and contact face.

FIG. 21A is a schematic diagram of an active hinge having a locking mechanism in a locked state, in accordance with an illustrative embodiment;

FIG. 21B is a schematic diagram of an active hinge of FIG. 21A having a locking mechanism in an unlocked state, in accordance with an illustrative embodiment;

FIG. 22A is a schematic diagram of an active hinge having a linearly moveable locking mechanism in a locked state, in accordance with an illustrative embodiment;

FIG. 22B is a schematic diagram of an active hinge of FIG. 22A having a linearly moveable locking mechanism in an unlocked state, in accordance with an illustrative embodiment;

FIG. 23 is a perspective view of a deploy bracket, body bracket, hood bracket and pawl of a third example embodiment of an active hinge illustrating that the deploy bracket is unable to move upward and rearward in some arrangements due to interference from vehicle components and body metal;

FIG. 24 is a first side perspective view of a hood bracket in a closed position relative to a deploy bracket of the third example embodiment of an active hinge;

FIG. 25 is a first side perspective view of a hood bracket in an open position relative to a deploy bracket of the third example embodiment of an active hinge;

FIG. 26 is a first side perspective view of the third example embodiment of an active hinge moving a hood in an upward and forward position, which may cause interference with a part of a vehicle body;

FIG. 27 is a first side perspective view of a fourth example embodiment of an active hinge;

FIG. 28 is a second side perspective view of the fourth example embodiment of an active hinge;

FIG. 29 is another first side perspective view of the fourth example embodiment of an active hinge;

FIG. 30 is another first side perspective view of the fourth example embodiment of an active hinge;

FIG. 31 is a magnified view of an actuator and locking hook of FIG. 30;

FIG. 32 is a magnified view of a hood bracket, deploy bracket, pawl, actuator and locking hook of FIG. 30;

FIG. 33 is a second side perspective view of the locking hook of the fourth example embodiment of an active hinge, illustrating pivoting of the locking hook;

FIG. 34 is another first side perspective view of the fourth example embodiment of an active hinge illustrating a path of motion of the hood bracket during a normal pivoting, or non-active pedestrian protection operation, of the hood bracket;

FIG. 35 is a magnified view of the locking hook and actuator of FIG. 33;

FIG. 36 is a magnified view of a hood bracket, deploy bracket, pawl, locking hook and actuator of FIG. 31;

FIG. 37 is another second side perspective view of the locking hook of the fourth example embodiment of an active hinge, illustrating pivoting of the locking hook into alignment with a tab of the deploy bracket;

FIG. 38 is another second side perspective view of the locking hook of the fourth example embodiment of an active hinge, illustrating pivoting of the locking hook into alignment with a tab of the deploy bracket;

FIG. 39 is a second side perspective view of the actuator engaging a contact surface of the hood bracket of the fourth example embodiment of an active hinge, illustrating pivoting movement of the locking hook and the hood bracket and the pawl in response to engagement with an actuator;

FIG. 40 is a first side perspective view of the actuator providing movement of the hood bracket relative to the deploy bracket of the fourth embodiment of an active hinge, illustrating the deploy bracket fixed in place relative to the body bracket by the locking hook;

FIG. 41 is a first side perspective view of the actuator providing further movement of the hood bracket relative to the deploy bracket of the fourth embodiment of an active hinge, illustrating the deploy bracket fixed in place relative to the body bracket by the locking hook; and

FIG. 42 is a flow chart of a method for assembling an active hinge for a motor vehicle, in accordance with an illustrative embodiment.

Corresponding reference numerals indicate corresponding parts throughout the several view of the drawings.

### DETAILED DESCRIPTION

Example embodiments of a vehicle hood assembly having a hood and at least one active hinge embodying the teachings of the present disclosure will now be described more fully with reference to the accompanying drawings. However, the example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that the example embodiments may be embodied in many different forms and that neither should be construed to limit the scope of the disclosure. In some example embodiments, well-known processes, well-known device structures, and well-known technologies are not described in detail.

As will be detailed, the active hinges of the present disclosure are used as part of a hood assembly for a pedestrian protection system on motor vehicles. More specifically, active hinges of the type disclosed herein are used for mounting a vehicle hood to a vehicle body in an effort to introduce an additional degree of freedom in the movement of the vehicle's hood when a pedestrian is struck by the vehicle to reduce the severity of injuries sustained when the pedestrian contacts the vehicle's hood.

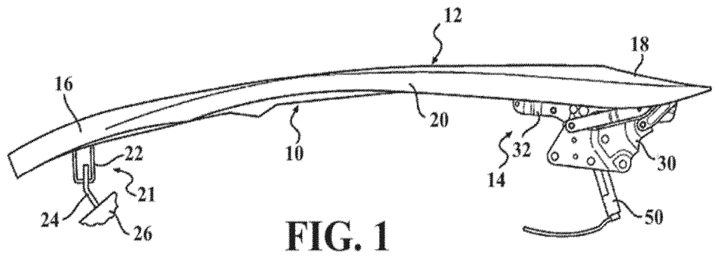

FIG. 1 illustrates a side elevational view of a vehicle hood assembly 10 generally configured to include a hood 12 and at least one active hinge 9. The term “vehicle” is intended to broadly encompass any car, truck, SUV, van or any other type of passenger carrying vehicle. Hood assembly 10 is configured to overlie an engine compartment of the vehicle, as defined by the vehicle's body. Hood 12 is shown to include a front segment 16, a rear segment 18 and a pair of laterally-spaced side segments 20. As is conventional, front segment 16 of hood 12 is configured to be located proximate to a front portion of the vehicle while rear segment 18 of hood 12 is configured to be located proximate to the vehicle's windshield.

In accordance with one example embodiment, a pair of active hinges 9 (only one shown) are associated with hood assembly 10, each being located adjacent to one of side segments 20 of hood 12 and being configured to allow hood 12 to pivot between an open position with front segment 16 elevated to provide access to engine compartment and a normal-closed position whereat hood 12 is lowered to provide an unobstructed view for the person operating the vehicle. FIG. 1 illustrates active hinge 9 positioned such that hood 12 pivots in proximity to its rear segment 18. The vehicle is also equipped with a hood latching device 21 shown to include a striker 22 fixed to an underside portion of front segment 16 of hood 12 and a latch 24 mounted to a structural portion 26 of the vehicle's body. In particular, FIG. 1 illustrates striker 22 engaged and held by latch 24 so as to located hood assembly 10 in its normal-closed position with active hinge 9 maintained in a “non-deployed” condition, whereby front segment 16 of hood is latched and rear segment 18 of hood 12 is located in its conventional lowered position.

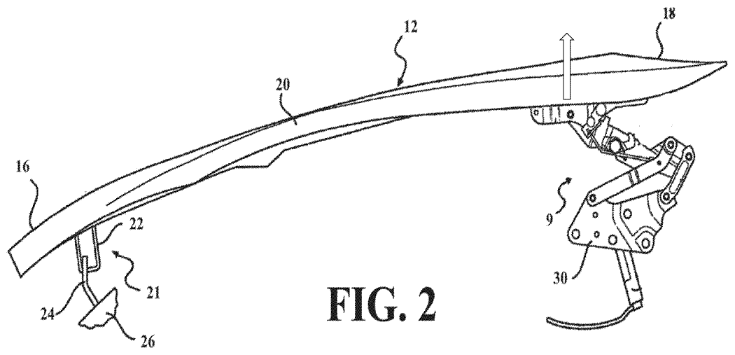

As will be detailed, active hinge 9 includes a pedestrian protection device that functions automatically in the event of a vehicle impact with a pedestrian. Specifically, the pedestrian protection device functions to shift active hinge 9 from its non-deployed state into a “deployed” condition, as shown in FIG. 2, where rear segment 18 of hood 12 is moved to a raised or deployed position while front segment 16 of hood 12 remains latched via latching device 21. Thus, active hinge 9 provides an additional degree of freedom in its movement to permit rear segment 18 of hood 12 to move from its normal lowered position (FIG. 1) into its raised position (FIG. 2). As will also be detailed, under normal (i.e., pre-collision) situations, this additional degree of freedom is disabled by a primary latch of a latching mechanism associated with active hinge 9 which, in turn, permits normal usage of hood 12. Normal usage is understood to mean pivotal movement of hood 12 between its normally-closed position of FIG. 1 and a normally-opened position (not shown) with active hinge 9 maintained in its non-deployed state. Release of the primary latch (via an actuator) functions to initiate shifting of active hinge 9 from its non-deployed state to its deployed state.

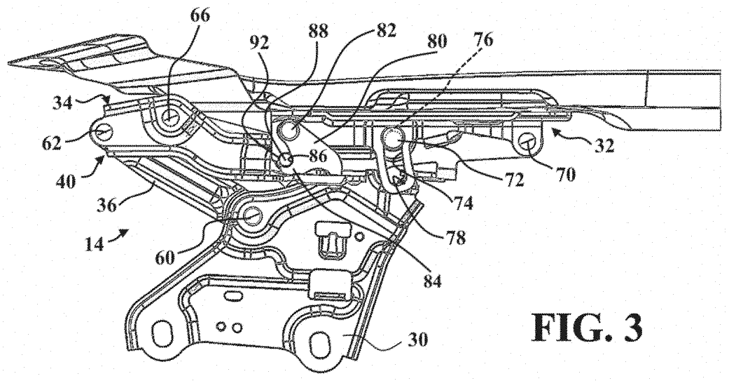

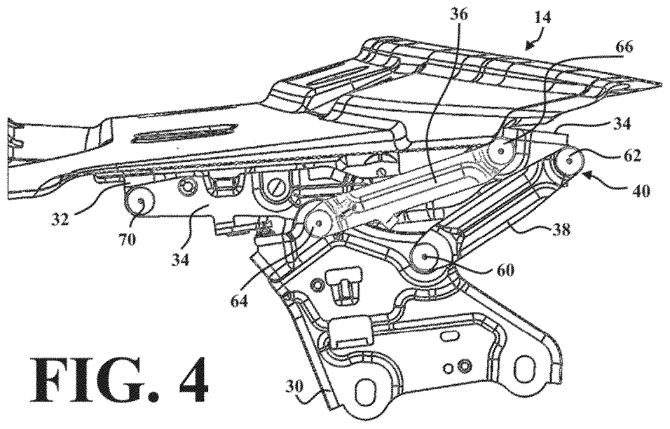

FIGS. 3-9 present a first embodiment of an active hinge 14 according to another aspect of the disclosure. FIG. 3 presents the active hinge 14 in its non-deployed condition. The active hinge 14 generally includes a body bracket 30, a hood bracket 32, a deploy bracket 34, and a pivot linkage mechanism interconnecting the body bracket 30 and deploy bracket 34. As best shown in FIG. 4, the pivot linkage mechanism includes a first link 36 and a second link 38 arranged to define a four-bar linkage 40. The first link 36 has one end pivotally connected to the body bracket 30 via a first pivot pin 60 and its opposite end pivotally connected to deploy bracket 34 via a second pivot pin 62. Similarly, second link 38 is shown having a first end pivotally connected to body bracket 30 via a first pivot pin 64 and its second end pivotally connected to deploy bracket 34 via a second pivot pin 66. A third pivot pin 70 pivotally connects a terminal end segment of deploy bracket 34 to the hood bracket 32.

With reference back to FIG. 3, a fourth pin 72 further interconnects the deploy bracket 34 and the hood bracket 32. The fourth pin 72 is spaced from the third pivot pin 70 along the hood bracket 32. The hood bracket 32 defines an elongated slot 74 that receives the fourth pin 72. The slot extends between a first end 76 and a second end 78. During pivoting of the hood bracket 32 relative to the deploy bracket 34 about the third pivot pin 70, the fourth pin 72 slides between, and is limited in movement by the first and second ends 76, 78 of the slot 74 to limit the rotational range of the hood bracket 32 relative to the deploy bracket 34 between a deployed position in which the fourth pin 72 engages the second end 78 of the slot 74, and a non-deployed position in which the fourth pin 72 engages the first end 76 of the slot 74.

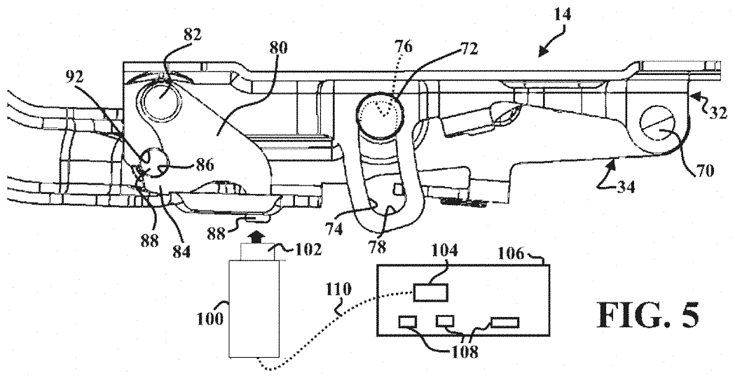

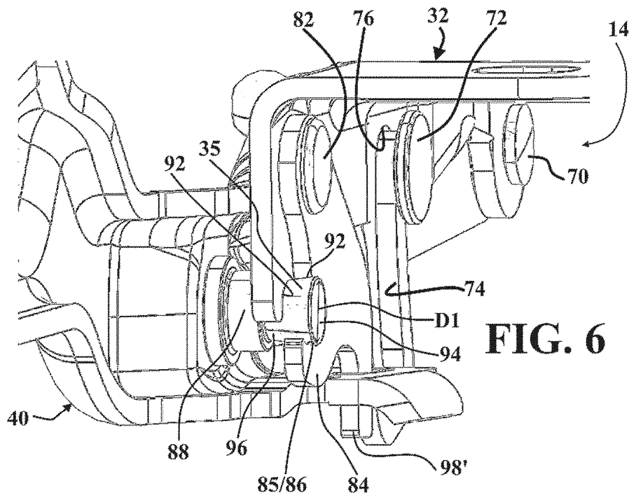

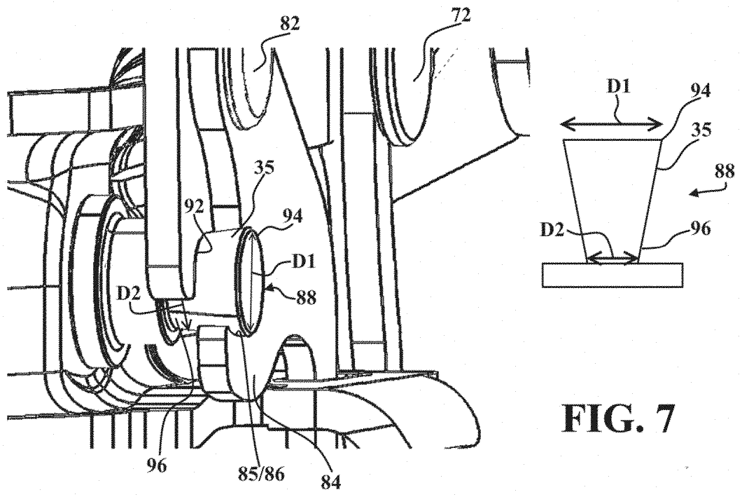

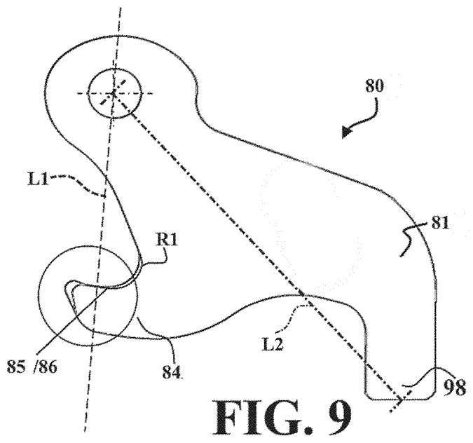

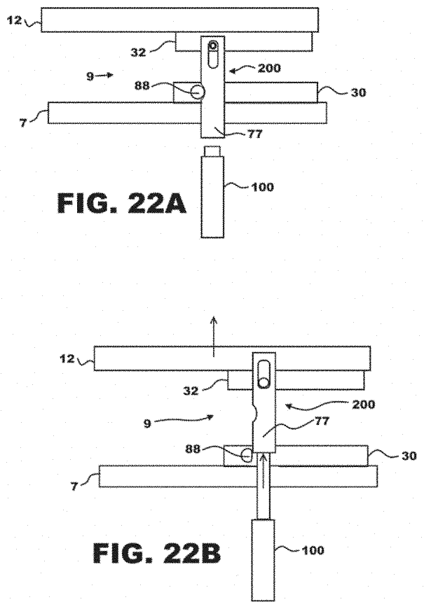

A pawl 80, and example of a locking mechanism, is pivotally connected to the hood bracket 32 along a fifth pin 82. The pawl 80 acting as an illustrative type of moveable lever includes a hook portion 84 that has an engagement face 85 which defines a lower pocket 86. The hook portion 84 is spaced from the fifth pin 82. A safety bolt 88 is fixed to the deploy bracket 34. The hook portion 84 of the pawl 80 is configured to partially surround a bottom portion 90 of the safety bolt 88, while the pawl 80 is positioned in a locked position (e.g., as shown in FIGS. 5-7), such that the safety bolt 88 is received by the lower pocket 86 of the pawl 80 to inhibit pivoting of the hood bracket 32 relative to the deploy bracket 34 about the third pivot pin 70. More particularly, according to this embodiment, the lower pocket 86 surrounds approximately half of the safety bolt 88. As best illustrated in FIG. 6, the hood bracket 32 defines an upper pocket 92 that is configured to partially surround a top portion 91 of the safety bolt 88 while the hood bracket 32 is in the non-deployed position. As best illustrated in FIGS. 6-7A, the safety bolt 88 has a generally frusto-conical shape and tapers from a wider portion 94 spaced from the deploy bracket 34 to a narrower portion 96 coupled with and received by the deploy bracket 34 along a tapered region 35. The wider portion 94 has a first diameter D1 that is larger than a second diameter D2 of the narrower portion 96. According to an embodiment, during assembly of the active hinge 14, the safety bolt 88 initially has a generally cylindrical shape, and is riveted or otherwise coupled to the deploy bracket 34 to provide an axial compressive force thereto, creating the tapered wall of the safety bolt 88 to drive flared portion of the safety bolt against the engagement face 85 of the pawl 80 to establish a tensed relationship(s), where a movement of the pawl 80 due to the expanded bolt is prevented by the secured fixing of the pawl 80 about the pivot axis 82. According to an embodiment, during assembly of the active hinge 14, the safety bolt 88 initially has a generally cylindrical shape, and is riveted or otherwise coupled to the deploy bracket 34 to provide an axial compressive force thereto, creating the tapered wall of the safety bolt 88 to drive the pawl 80 and deploy bracket 34 in opposite directions from one another to fix the hood bracket 32 in the non-deployed position to establish tensed relationship(s). It should be appreciated that the safety bolt 88 may have other tapered shapes, and the tapered shape may be provided in other ways. Tapered shapes may include a budging shape with a gradual reduction in thickness, or an abrupt reduction in thickness, or an uneven reduction in thickness. As illustrated in FIG. 9, the hook portion 84 and lower pocket 86 of the pawl 80 generally have an arc shape with a radius of curvature that is sized such that the tapered safety bolt 88 may be received and secured within the pocket 86 of the pawl 80. It should be appreciated that fixing the hood bracket 32 in the non-deployed position in this manner with the frustoconical shaped safety bolt 88, and arc-shaped pocket 86 of the pawl 80 advantageously eliminate the need for a spring to hold the hood bracket 32 in the non-deployed position, and prevents noise, rattling and vibrations because the components of the active hinge 14 are held in tension. Holding the components of the active hinge 14 in tension in this manner also eliminates tolerances. Other types of locking mechanisms may be provided in tensed relationship with the bolt 88, such as a sliding lever 77 configured to linearly move having a protrusions for engaging the bolt 88, or a sliding mechanism having detents for engaging the bolt 88, or a rotating mechanism having detents for receiving a portion of the bolt 88 (see for example FIGS. 22A and 22B), as examples and without limitation.

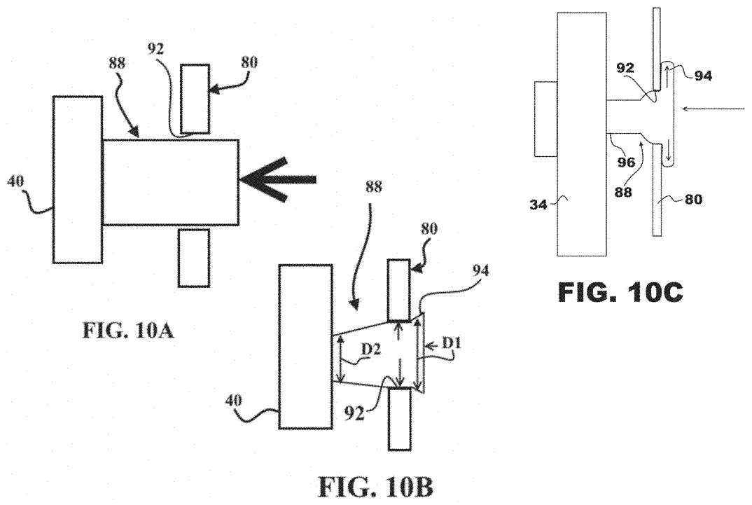

It should be appreciated that the safety bolt 88 may be pre-compressed into position during early stages of manufacturing, or after all of the components of the active hinge 14 are assembled and with the pawl 80 in the locked position. More particularly, as illustrated in FIGS. 10A-10B, during assembly of the active hinge 14, the safety bolt 88 is aligned with /positioned in the lower pocket 86 of the pawl 80 (FIG. 10A). Subsequently, as shown in FIG. 10B, the safety bolt 88 is axially crushed to form its frusto-conical shape, which causes the safety bolt 88 to be locked within the pocket 86 of the pawl 80. As a result, any radial clearance between the safety bolt 88 and pawl 80 is eliminated, therefore providing an anti-chucking effect.

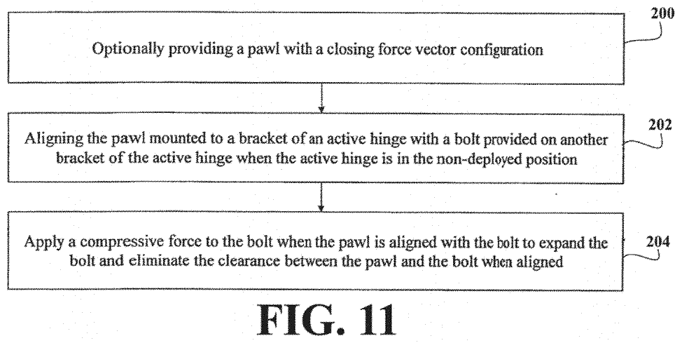

FIG. 11 presents a method of assembling the active hinge 14 according to an aspect of the disclosure. The method includes 200 providing a pawl 80 with a closing force vector configuration. The method continues with 202 axially aligning the pocket 86 of the pawl 80 with the safety bolt 88. As will be clarified below, it should be appreciated that the pawl 80 and safety bolt 88 may be attached to any of the brackets 30, 32, 34 or links 36, 38, but should be positioned on different brackets 30, 32, 34 and links 36, 38 than one another. The method continues with 204 applying an axial compressive force to the safety bolt 88 when the pocket 86 of the pawl 80 is aligned with the safety bolt 88 to expand the safety bolt 88 and eliminate radial gaps between the safety bolt 88 and pawl 80.

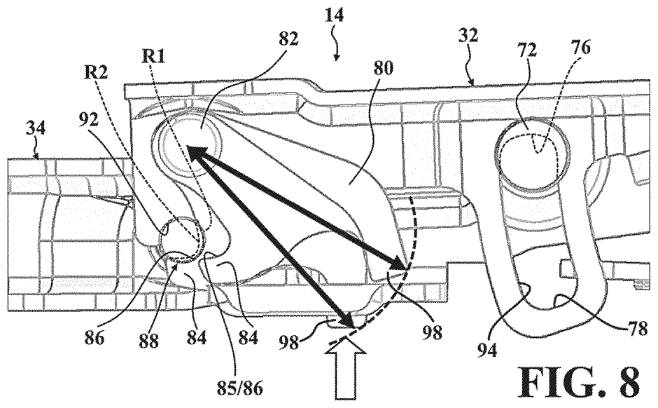

As best shown in FIGS. 5 and 8-9, the pawl 80 further includes a contact face 98 that is spaced from the fifth pin 82 and the hook portion 84 of the pawl 80. As shown, a first distance L1 between the pivot fifth pin 82 and the engagement face 85 is about twice that of a second distance L2 between the fifth pin 82 and the contact face 98. An actuator 100 is positioned in alignment with the contact face 98. The actuator 100 includes a linearly extendable contact member 102 for engaging the contact face 98 to cause the pawl 80 to rotate about the fifth pin 82 from the locked position into an unlocked position (illustrated in FIG. 8). Rotating the pawl 80 into the unlocked position allows the hood bracket 32 to pivot about the third pivot pin 70 relative to the deploy bracket 34 to allow the hood bracket 32 and hood to move into the deployed position. It should be appreciated that other components of the active 14 may be configured to move relative to one another in a similar manner in response to actuation of the actuator 100 or other actuators. As schematically illustrated in FIG. 5, the actuator 100 is configured to selectively actuate in response to a control signal being provided by a controller 104 associated with an active passenger protection control system 106 in response to one or more vehicle-mounted sensors 108 or other detection devices detecting the occurrence of a pedestrian collision. In the example shown, the actuator 100 includes an electrical connector 110 that would be in electrical connection with the sensor(s) 180 and/or the controller 104 such that an electrical control signal is generated to control actuation of the actuator 100.

It should be appreciated that a one-joint assembly may be utilized as an alternative to the four-bar linkage 40 of the first embodiment of the active hinge 14.

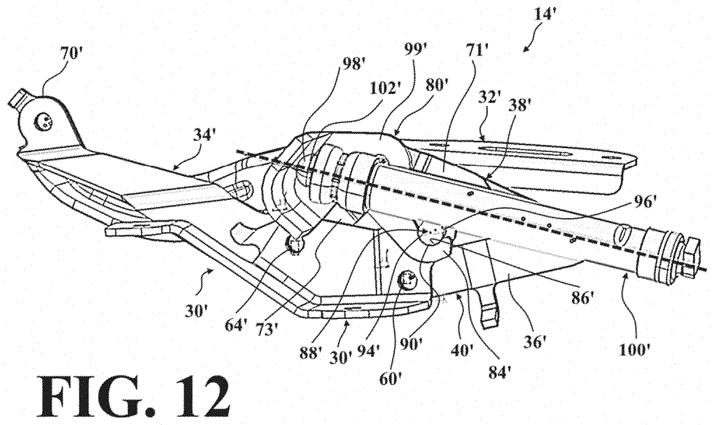

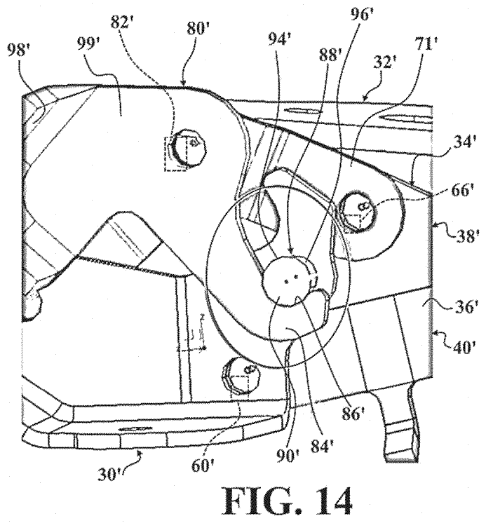

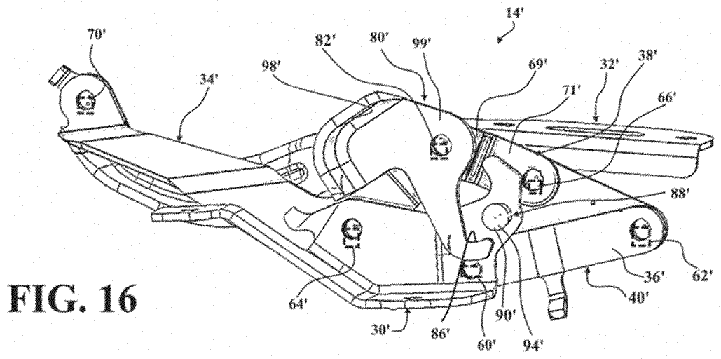

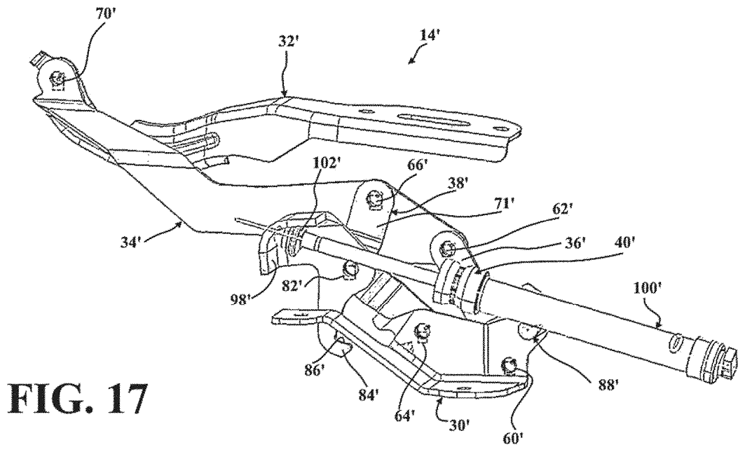

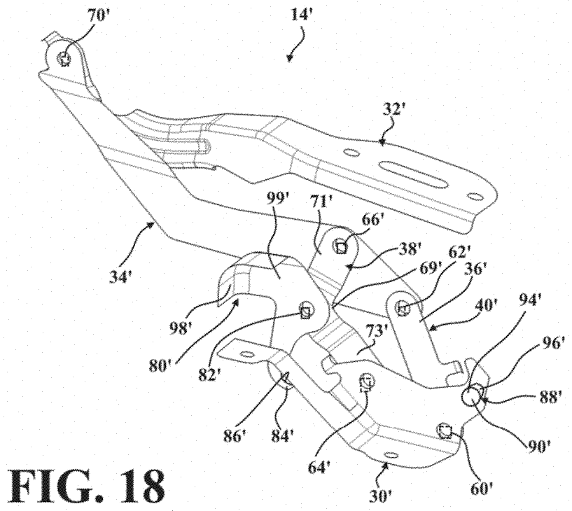

FIGS. 12-18 disclose a second embodiment of an active hinge 14′ according to another aspect of the disclosure. As best illustrated in FIG. 18, similar to the first embodiment of an active hinge 14, the active hinge 14′ generally includes a body bracket 30′, a hood bracket 32′, a deploy bracket 34′, and a pivot linkage mechanism interconnecting the body bracket 30′ and deploy bracket 34′. The pivot linkage mechanism includes a first link 36′ and a second link 38′ arranged to define a four-bar linkage 40′. The first link 36′ has one end pivotally connected to the body bracket 30′ via a first pivot pin 60′ and its opposite end pivotally connected to the deploy bracket 34′ via a second pivot pin 62′. Similarly, second link 38′ is shown having a first end pivotally connected to body bracket 30′ via a first pivot pin 64′ and its second end pivotally connected to deploy bracket 34 via a second pivot pin 66′. The second link generally has an “L” shape and defines an elbow portion 69′ between first and second linear segments 71′, 72′ that extend generally perpendicularly to one another. A third pivot pin 70′ pivotally connects a terminal end segment of deploy bracket 34′ to the hood bracket 32′.

According to the second embodiment of the active hinge 14′, there is no fourth pin and corresponding slot 74 limiting pivoting movement of the hood bracket 32′ relative to the body bracket′ about the third pivot pin 70′ like in the first embodiment of the active hinge 14.

A pawl 80′ is pivotally connected to the elbow portion 69′ of the of the second link 38′ along a fifth pivot pin 82′. The pawl 80′ includes a hook portion 84′ that has an engagement face 85′ that defines a lower pocket 86′. The hook portion 84′ is spaced from the fifth pin 82′. A safety bolt 88′ is fixed to the body bracket 30′. The lower pocket 86′ of the hook portion 84′ of the pawl 80′ is configured to partially surround a bottom portion 90′ of the safety bolt 88′, while the pawl 80′ is positioned in a locked position (e.g., as shown in FIGS. 12-14), such that the safety bolt 88′ is received by the lower pocket 86′ of the pawl 80′ to inhibit pivoting of the second link 38′ and deploy bracket 34′ relative to the body bracket 30′ about the third pivot pin 70′. Like the first embodiment of the active hinge 14′, the safety bolt 88′ has a generally frustoconical shape and tapers between a wider portion 94′ spaced from the body bracket 30′ to a narrower portion 96′ coupled with the body bracket 30′. The wider portion 94′ has a larger diameter than the narrower portion 96′. During assembly of the active hinge 14′, the safety bolt is riveted or otherwise connected to the body bracket 30′ such that the tapered wall of the safety bolt 88′ drives the pawl 80′ downwardly to fix the deploy bracket 34′ in the non-deployed position relative to the body bracket 30′. It should be appreciated that fixing the deploy bracket 34′ in the non-deployed position in this manner with the frustoconical shape safety bolt 88′ advantageously eliminates the need for a spring to hold the deploy bracket 34′ in the non-deployed position and prevents noise, rattling and vibrations because the components of the active hinge 14′ are held in tension. Holding the components of the active hinge in tension in this manner also eliminates tolerances.

It should also be appreciated that, according to either of the aforementioned embodiments, the safety bolt 88, 88′ may be pre-compressed into position as discussed during early stages of manufacturing or after all of the components of the active hinge 14, 14′ are assembled and with the pawl 80, 80′ in the locked position. Alternatively, the safety bolt 88, 88′ may be fabricated such that it tapers prior to being installed on the active hinge 14, 14′, with the safety bolt 88, 88′ driving the pawl 80, 80′ into an opposite direction as the opposing component of the active hinge 14, 14′ during axial movement of the safety bolt 88, 88′ to create tension in the components of the active hinge 14, 14′.

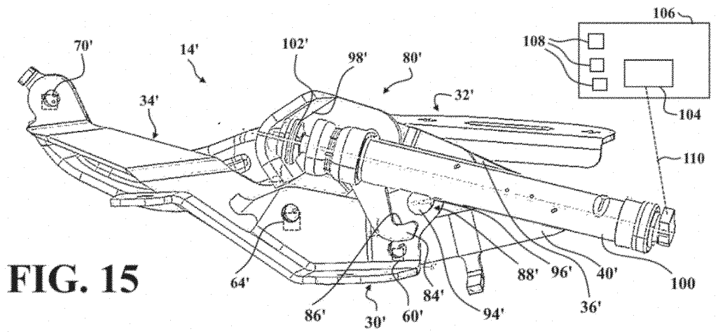

The pawl 80′ further includes a contact face 98′ that is spaced from the fifth pin 82′ and the hook portion 84′ of the pawl 80′. According to this embodiment, the contact face 98′ extends transversely from a planar body portion 99′ of the pawl 80′. As best illustrated in FIGS. 12, 15 and 17, an actuator 100′ is positioned in alignment with the contact face 98′. The actuator 100′ includes a linearly extendable contact member 102′ for engaging the contact face 98′ to cause the pawl 80′ to rotate about the fifth pin 82′ from the locked position into an unlocked position (illustrated in FIGS. 15-18). Rotating the pawl 80′ into the unlocked position allows the second link 38′ to pivot about the first pivot pin 64′, and thus allows the deploy bracket 34′ to pivot into the deployed position, thus also allowing the hood bracket 32′ and hood to move into the deployed position. It should be appreciated that other components of the active 14′ may be configured to move relative to one another in a similar manner in response to actuation of the actuator 100′ or other actuators.

It should be appreciated that the pawl 80, 80′ of both embodiments of active hinge 14, 14′ require a small release angle to be rotated into the unlocked position due to the relative positions between the contact face 98, 98′, the pocket 86, 86′ and the fifth pin 82, 82′. Accordingly, only a small actuator stroke is required to rotate the pawl 80, 80′ into the unlocked position.

As schematically illustrated in FIG. 15, the actuator 100′ is configured to selectively actuate in response to a control signal being provided by a controller 104′ associated with an active passenger protection control system 106′ in response to one or more vehicle-mounted sensors 108′ or other detection devices detecting the occurrence of a pedestrian collision. In the example shown, the actuator 100 includes an electrical connector 110 that would be in electrical connection with the sensor(s) 180 and/or the controller 104 such that an electrical control signal is generated to control actuation of the actuator 100′.

It should be appreciated that the pawl 80, 80′ and safety bolt 88, 88′ may alternatively be placed on another of the body bracket, 30, hood bracket 32, deploy bracket 34 or links 36, 38 without departing from the scope of the subject disclosure. It should also be appreciated that the second embodiment of an active hinge 14′ may be assembled in accordance with the method presented in FIG. 11.

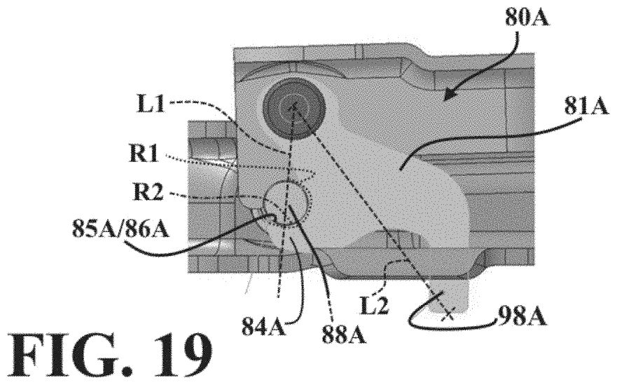

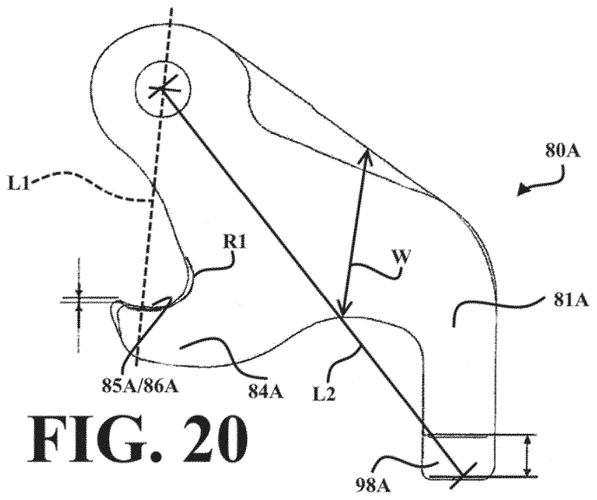

FIGS. 19-20 present a third embodiment of a pawl 80A according to an aspect of the disclosure. According to this embodiment, the lower pocket 86A of the hook portion 84A of the pawl 80A is extended such that it surrounds more than half of the outer circumference of the safety bolt 88 to provide increased locking security while the pawl 80A is positioned in the locked position. As shown, a first distance L1 between the pivot fifth pin 82 and the engagement face 85 is more than twice that of a second distance L2 between the fifth pin 82 and the contact face 98. This provides a further reduced actuator stroke length for moving the pawl 80A from the locked to unlocked position.

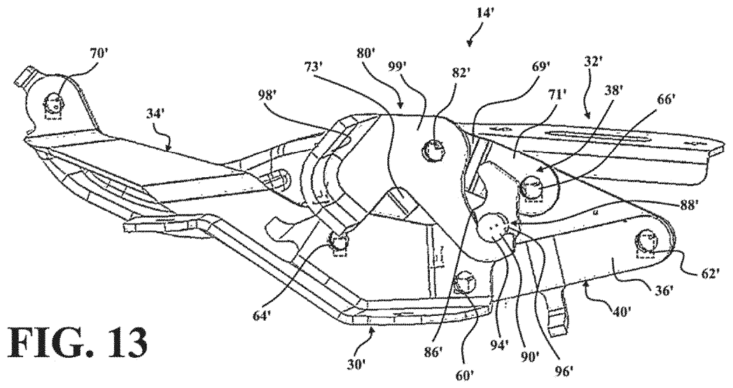

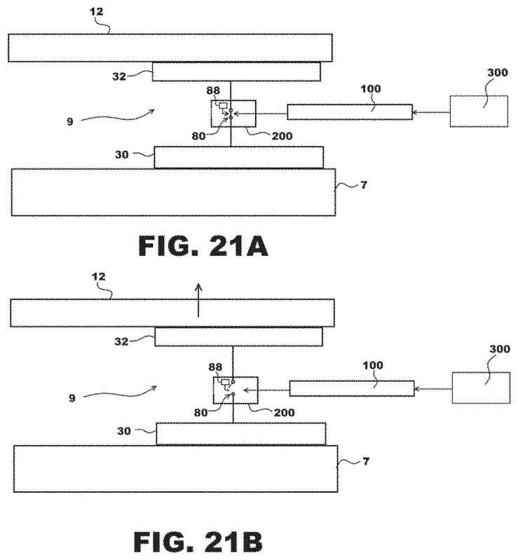

Now referring to FIG. 21A and FIG. 21B, in addition to FIGS. 1 through 20, an active hinge 9 is provided and includes a hood bracket 32 for attachment to a vehicle hood 12, a body bracket 30 for attachment to a vehicle body, and may include a number of intermediary components such as bracket 34 and linkages 36, 38, for example. A locking mechanism 200, for example pawl 80, is coupled between the hood bracket 32 and the body bracket 30, the locking mechanism 200 comprising an unlocked state for example as shown in FIGS. 8 and 15 for allowing the hood bracket 32 to move away (e.g. upwardly) from the body bracket 30 and a locked state for example as shown in FIG. 5 and FIG. 13 preventing the hood bracket 32 to move away from the body bracket 30, the locking mechanism 200 further comprising a bolt 88 in a tensed relationship with the locking mechanism 200 for maintaining the locking mechanism 200 in the locked state. An actuator 100 is provided for selectively actuating, for example a pyrotechnic actuator deploying a plunger in response to receiving an electrical signal corresponding to a detection of a pedestrian impact from a controller 300 or by a body control module (BCM), the locking mechanism for transitioning the locking mechanism 200 from the locked state to the unlocked state, such that the selectively actuating the locking mechanism 200 relieves the tensed relationship to allow the locking mechanism 200 to transition from the locked state to the unlocked state, and allow the hood 12 to be deployed to an active pedestrian protection position as shown in FIG. 21B (illustrating the hood 12 allowed to move upwards by a continued actuation of actuator 100, or by another actuation system/mechanism not shown). During the relief of the tensed relationship, for example the pawl 80 disengaging the bolt 88, the tension may momentarily increase or the tension may remain the same, or the tension may decrease, depending on the geometry of the pawl 80 and desired level of safety and the size of the actuator 100. The locking mechanism 200 may include a moveable lever, illustrated as a pivotal pawl 80, configured for movement (e.g. linear movement or rotational movement) between a locked position and an unlocked position, with the moveable lever having an engagement surface, also referred to hereinabove as engagement face 85, for tensed engagement with the bolt 88 when the moveable lever is in the locked position to establish the locking state of the locking mechanism 200. The configuration whereby the moveable lever is a pawl 80 configured for pivotal movement about a pivot axis 82 between a locked position and an unlocked position, the pawl 80 has an engagement surface, for example engagement face 85, for engagement with the bolt 88 when the pawl 80 is in the locked position to establish the locking state of the locking mechanism 200, with the tensed relationship established by a portion of the bolt 88, for example shown as approximately 50% of the outer circumferential surface of the bolt 88 as seen in FIG. 8 exerting a force F against the engagement surface 85 of the pawl 80 biasing the pawl 80, for example via the engagement surface 85, away from the pivot axis 82. The tensed relationship, for example due to the expansion forces of the bolt 88 acting on the pawl 80, is established when the pawl 80 is in the locked position and a portion (e.g. flared head) of the bolt 88 is in an expanded state relative to the other portion of the bolt 88 (e.g. unflared stem). Illustratively as shown in FIG. 10B the expanded state of the bolt 88 is shown as a flared head portion, or top portion 91, due to an applied compression of the bolt 88 in a pre-assembly state where the bolt 88 may be for example a linear pin or straight cylindrical structure, for example during positioning of the pawl 80 in the locked position, to deform the pin to an assembled state where it may engage with upper pocket 92. A further applied compression of the bolt 88 may be provided to further spread out the upper pocket 92 to further engage the planar surface 95 of the pawl 80, as shown in FIG. 10C. The pawl 80 has a hook portion 84 having the engagement surface defining a pocket 86 receiving the bolt 88, and for example partially receiving the bolt 88, such that at least a portion of the bolt 88 is in a path blocking a motion of the hook (e.g. counterclockwise as shown in FIG. 8) when the pawl 80 is in the locked position, for preventing vibrations due to movement e.g. chucking of the pawl 80 against the bolt 88. The at least a portion of the bolt 88 may remain in a path blocking a motion of the hook 84 (e.g. counterclockwise as shown in FIG. 8) when the pawl 80 is being moved from the locked position towards the unlock position. Selectively actuating the locking mechanism 200 e.g. releasing the locking mechanism 200 causes the hook 84, which may be for example the tip of hook 84, to bypass the portion of the bolt 88 blocking the motion of the hook 84, such that the hook 84 bypassing the portion of the bolt 88 blocking the motion of the hook 84 causes a localized deformation of at least one of the bolt 88 and the pawl 80. As a result of the tensed relationship established between the pawl 80 and the bolt 88, the pawl 80 may be maintained in the locked position without use of a spring, for example which may otherwise be required to bias the pawl 80 in the clockwise direction as viewed in FIG. 8 and prevent vibrations. The use of a bolt in lieu of a spring is lower cost and easier to assemble and provide increases in securing of the pawl 80. When in the tensed relationship, the applied force exerted by the expanded bolt 88 may increase the coefficient of friction between the bolt 88 and the engagement surface 85 enhancing the securing of the pawl 80 against movement. During movement of the pawl 80, such increase in the coefficient of friction is overcome by the force of the actuator 100, which may not be overcome due to vibrations during normal operation of the vehicle e.g. driving. The pawl surface 85 may therefore be caused to slide against the bolt 88 with resistance proportional to the expansion force of the bolt 88 during movement of the pawl 80 from its locked position to its unlocked position. In additional to frictional forces resisting a relative movement of the pawl 80 along the bolt 88, after expansion of the bolt 88 to its flared or expanded assembled state, the flared portion of the bolt 88 may adopt a blocking position against a movement of the pawl 80, for example hook portion 84 of pawl. Hook portion 84 may therefore not only increase the surface contact area of the pawl 80 with the bolt 88 e.g. the outer flared perimeter of the bolt 88, but also the bolt 88 may block the hook portion 84. As a result, during release, hook portion 84 in order to bypass the blocking positioning of the expanded bolt 88 may be caused due to the force of the actuator 100 to slightly deform a portion of the perimeter of the bolt 88. For example the perimeter of the bolt 88 may be deformed by the hook 84 scrapping or indenting or the like the perimeter of the bolt 88, or the hook portion 84 may cause a larger bending or deflection of the bolt 88, or the hook portion 84 itself may be deformed, for example bent to allow the pawl 80 to move from the locked position to the unlocked position, depending on the relative strength of the materials of the pawl 80 and the bolt 88. In an embodiment, the bolt 88 may be pivotally mounted such that during the pawl 80 moving from the locked position to the unlocked position the engagement of the pawl 80 with the bolt 88 may cause the bolt to rotate e.g. counterclockwise as shown in FIG. 8.

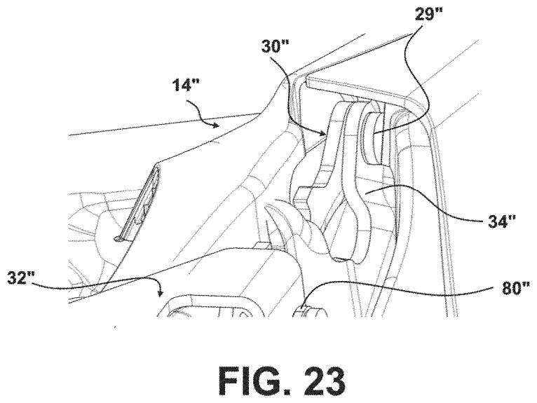

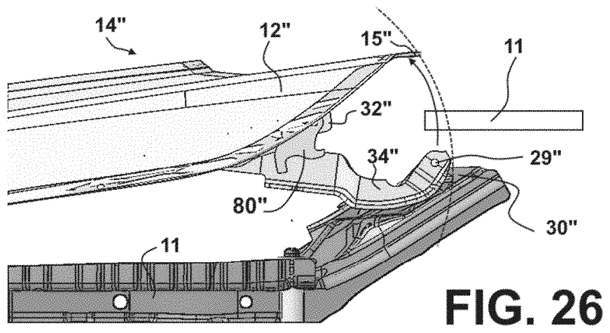

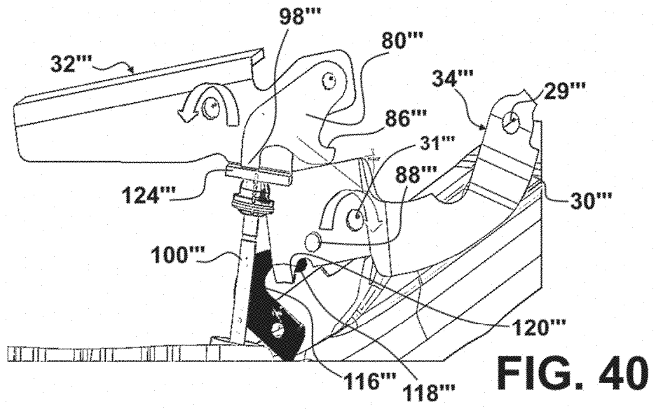

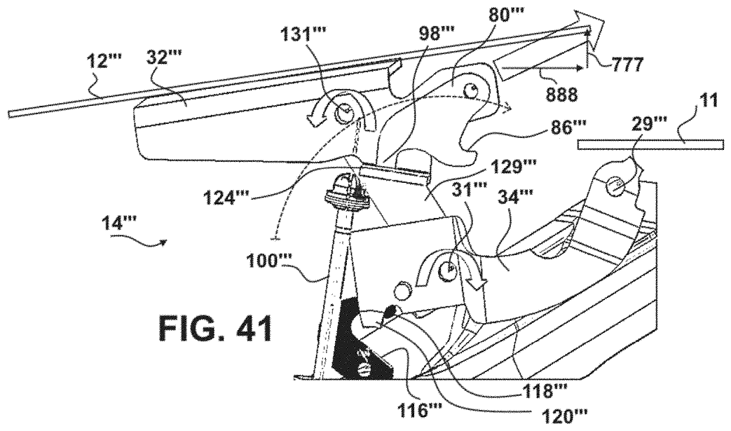

Now referring to FIGS. 40 and 41 illustrate a third embodiment of an active hinge 14″ according to another aspect of the disclosure. Active hinge 14″ permits hood bracket 32″ to move upwardly and rearwardly while deploy bracket 34″ is prevented from moving about its pivot point 29″ or coupling with body bracket 32′″. As a result the active hinge 14″ is allowed to be positioned in an active pedestrian deployed position without during its movement interfering with surrounding sheet metal of the vehicle body 11, which would be contacted by the deploy bracket 34″ and possibly damaged or limit the range of motion of the active hinge 14″ to its deployed position if allowed to move during an active pedestrian deployment position, for example with a configuration as shown in FIG. 23A and FIG. 26 where deploy bracket 34″ pivots about pivot point 29″ during an active deployment operation. As seen in FIG. 26, pivoting of hood bracket 32″ relative to deploy bracket 34″ may cause hood 12″ to interfere with an adjacent vehicle body 11, such as a body panel, wiper or the like, as illustrated by travel of a trailing edge 15″ of hood 14″ along an travel path show as a phantom art, in one example.

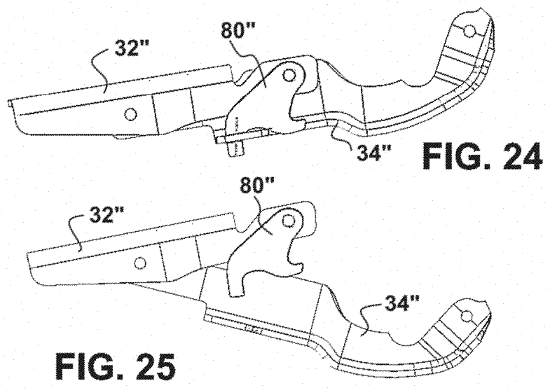

As best illustrated in FIGS. 24 and 25, the active hinge 14″ includes a hood bracket 32″ that is pivotally connected to a deploy bracket 34″. A pawl 80″ is pivotally connected to the hood bracket 32″. The pawl 80″ is pivotable between a locked position and an unlocked position, for example in a manner as described herein above. While in the locked position, pivoting movement of the hood bracket 32″ relative to the deploy bracket 34″ is inhibited, and while in the unlocked position, pivoting movement of the hood bracket 32″ relative to the deploy bracket 34″ is permitted. FIG. 24 illustrates the hood bracket 32″ in a closed, unpivoted positioned relative to the deploy bracket 34″ and with the pawl 80″ in the locked position. FIG. 25 illustrates the hood bracket 32″ in an open, pivoted position relative to the deploy bracket 34″ after the pawl 80″ has been moved into the unlocked position. The deploy bracket is pivotally connected to a body bracket 30″. FIG. 26 shows an possible interference between the hood edge 31″ with a surrounding portion of the vehicle body 11, such as a flare from a surrounding fender or of a fixed hood portion, as examples only, if hood 12″ moves about pivot point 29″, or in other words if the active hinge 14″ provides for a pivoting of deploy bracket 34″ about pivot point 29″ during movement of the hood 12″ to an active pedestrian deployment position.

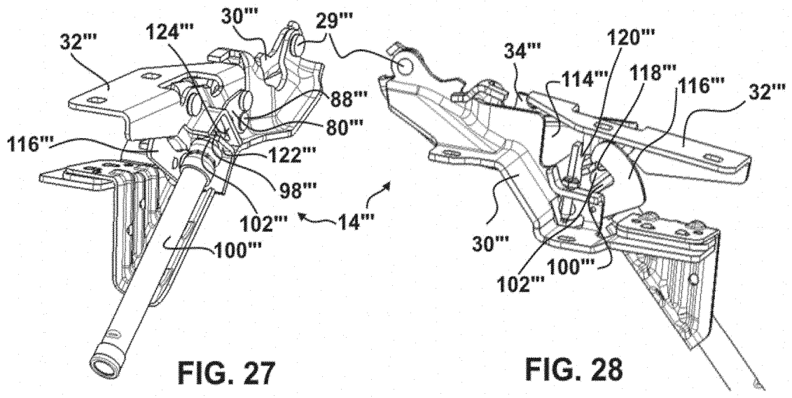

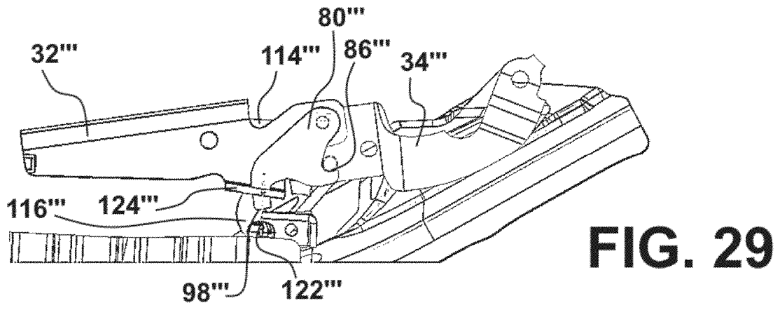

Now referring to FIGS. 27 to 29, active hinge 14′″ includes a locking hook 116′″ that is pivotally connected to the body bracket 30′″. The hook 116′″ presents an engagement flange 118′″ that is positioned for removably engaging a tab 120′″ of the deploy bracket 34′″. The locking hook 116′″ is pivotable between a first position in which the engagement flange 118′″ is spaced from the tab 120′″ thus allowing pivoting movement of the deploy bracket 34′″ relative to the body bracket 32′″, for example during a normal hood opening operation e.g. non-active pedestrian deployment operation, and a second position in which the engagement flange 118′″ engages the tab 120′″ for inhibiting pivoting of the deploy bracket 34′″ relative to the body bracket 32′″, for example during an active pedestrian deployment operation. The locking hook 116′″ further presents an actuation surface 122′″ that is positioned in axial alignment with an actuator 100′″. The portion of the actuation surface 122′″ that is axially aligned with the actuator 100′″ is radially spaced from the pivoting point 123″ of the locking hook 116″″, illustratively provided on the body bracket 34′″, which causes the locking hook 116′″ to rotate in response to linear movement of the actuator 100′″ to a position as shown in FIG. 29

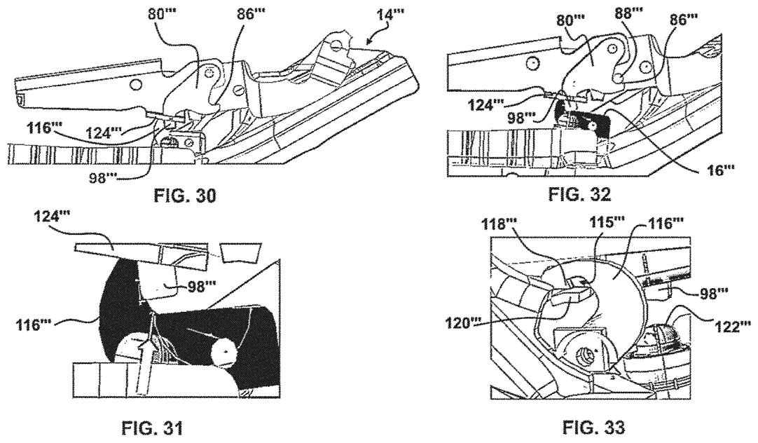

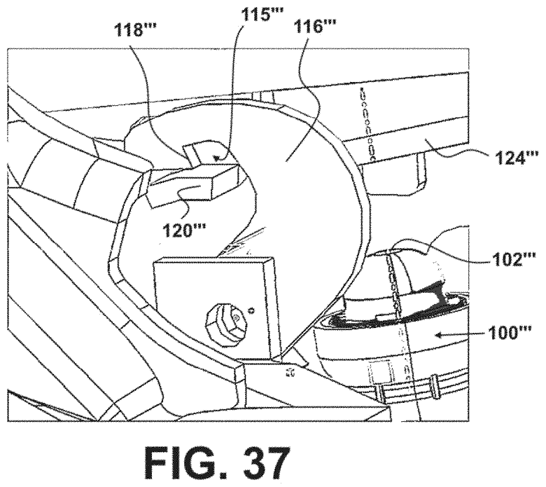

As illustrated in FIGS. 30-37, during operation, in response to a detection of an occurrence of a pedestrian collision, a linearly extendable contact member 102′″ of the actuator 100′″ is configured to move and engage the actuation surface 122′″ of the locking hook 116″″ thus moving the locking hook 116′″ into the second position and inhibiting pivoting of the deploy bracket 34′″ relative to the body bracket 32″″ effectively locking the deploy bracket 34′″ to the body bracket 32′″. Locking hook 116′″ is shown to include a recessed notch 115′″ for assisting with the locking by engagement with the tab 120′″, also referred to herein as an engagement feature, when moving the locking hook 116′″ into the second position. Engagement feature may be a protruding pin, a stamped or folded portion of the bracket 34′″ or a lug, or the like.

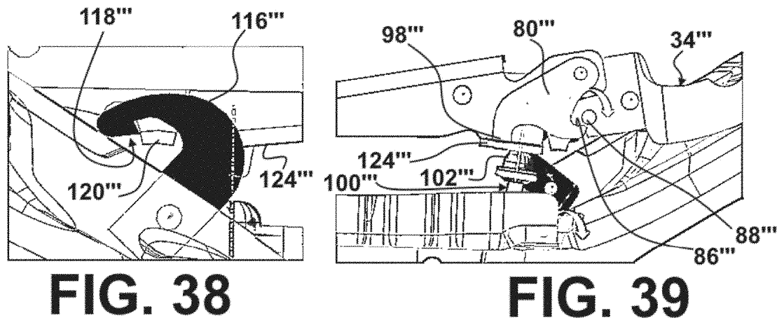

As illustrated in FIGS. 38-41, as the contact member 102′″ moves the actuation surface 122″″ the actuation surface 122′″ engages a contact face 98′″ of the pawl 80″″ which causes the pawl 80′″ to rotate from the locked position toward the locked position. After a predetermined amount of linear movement of the contact member 102′″ has occurred, the locking hook 116′″ has rotated enough such that it clears the contact member 102′″. At this point, the contact member 102″″ directly engages and pushes on a contact surface 124′″ of the hood bracket 32′. At this point, the pawl 80′″ has rotated into the unlocked position, thus allowing pivoting movement of the hood bracket 32′″ relative to the secondary lever 113′″, and pivoting movement of the secondary lever 113′″ relative to the body bracket 30′″. Because the deploy bracket 34′″ is inhibited from moving at this time by the locking hook 116″″, and because the secondary lever 114′″ is pivotable connected to the deploy bracket 23′″ at a location that is spaced from where the deploy bracket 23′″ is coupled with the body bracket 34″″ the hood bracket 32′″ (and hood 12′″) may move in an upward and rearward direction relative to the body bracket 30″″ as best illustrated in FIGS. 40 and 41.

Furthermore, because the deploy bracket 23′″ remains stationary and does not move upwards or rearwards during movement of the hood bracket 32′″ during an occurrence of a pedestrian collision, damage and interference with body panels and/or wiper motors, wiper linkages, etc. is prevented. It should also be appreciated that prior to firing of the actuator 100′″, the locking hook 116′″ is in the first position with the engagement flange 118′″ spaced from the tab 120′″ thus allowing pivoting movement of the deploy bracket 34′″ relative to the body bracket 32′″ and normal opening of the hood 12″.

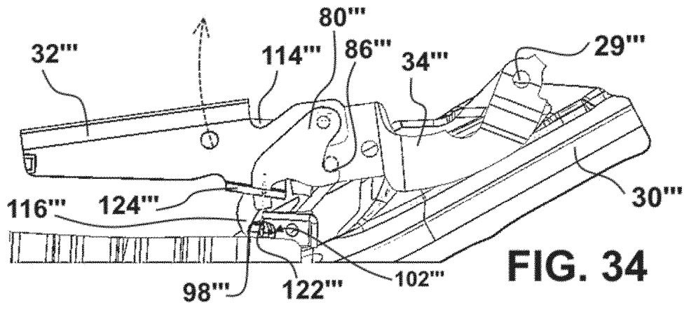

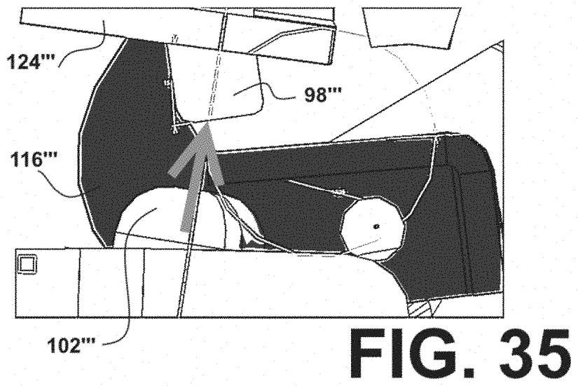

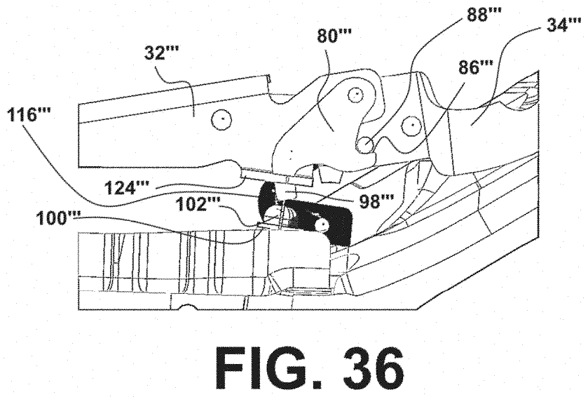

With reference to the figures herein, there is provided an active hinge 14′″ including a hood bracket 32′″ for attachment to a vehicle hood 14′″, a body bracket 30′″ for attachment to a vehicle body 11, a deploy bracket 34′″ pivotally attached between the hood bracket 32′″ and the body bracket 30′″, the hood bracket 32′″ being moveable relative to the body bracket 30′″ between a non-deployed position and a deployed position, a locking hook 116′″ pivotally mounted to one of the body bracket 30′″ and the deploy bracket, and an engagement feature 120′″ for engagement by the locking hook 116′″, the engagement feature 120′″ provided on another one of the body bracket 30′″ and the deploy bracket 34′″, and further including an actuator 100′″ for selectively pivoting the locking hook 116′″ for engaging the locking hook 116′″ with the engagement feature 120′″ to prevent the deploy bracket 34′″ from moving relative to the body bracket 30′″ and for moving the hood bracket 32′″ from the non-deployed position to the deployed position. The engagement feature 120′″ may be provided on the deploy bracket 34′″ and the locking hook 116′″ is pivotally mounted to the body bracket 30′″, as illustratively shown in FIG. 28. The deploy bracket 34′″ may be pivotally mounted to the body bracket 30′″ as illustratively shown in FIG. 27. At least one link 129′″, and one link shown in FIG. 41′ for illustrative purposes, may be provided for pivotally coupling the hood bracket 32′″ to the deploy bracket 34′″, for example pivotally coupled to the deploy bracket 34′″ at pivot 31′″ and to the hood bracket 32′″ at pivot 131″. As also illustrated in FIG. 41 for example, a pivot point 29′″ of the deploy bracket 34′″ relative to the body bracket 30′″ is offset from the pivot point 31′″ of the hood bracket 32′″ relative to the deploy bracket 34′″, to allow for example a different path of travel of the hood bracket 32′″ during a normal operation for example when pivoting about pivot point 29′″ as shown illustratively by phantom lines in FIG. 34 for example, and during an active pedestrian protection operation for example when pivoting about pivot point 31′″ as shown illustratively by phantom lines in FIG. 41. The hood bracket 32′″ when moved from the non-deployed position (FIG. 39) to the deployed position (FIG. 41), will follow a path of travel of the hood bracket 32′″ when the locking hook 116′″ is in engagement with the engagement feature 120′″ (FIG. 41) is different from a path of travel of the hood bracket 32′″ when the locking hook 116′″ is in disengagement from the engagement feature 120′″ (FIG. 34). The locking hook 116′″ includes a recessed notch 115′″ (FIG. 38) for receiving the engagement feature 120′″ when the engagement feature 120′″ is engaged with the locking hook 116′″. The engagement feature 120′″ may be a projecting tab, such as tab 120′″ formed with the deploy bracket 34′″, and for example formed from a folded portion of the deploy bracket 34′″ as shown. The active hinge 14′″ may further include a pawl 80′″ pivotally mounted to the hood bracket 32′″ for releasable coupling, such as the compressible connection described herein above as an example, to the deploy bracket 34′″ such that the actuator 10′″ selectively pivots the pawl 80″″ for disengaging the pawl 80″″ from the deploy bracket 34′″ (FIG. 39), to allow the hood bracket 32′″ to move from the non-deployed position to the deployed position in response to engagement of the actuator 100′″ with the hood bracket 32′″ (see FIGS. 40 and 41). The active hinge 14′″ may further include a bolt 88′″ for engagement by the pawl, the bolt 88′″ connected the deploy bracket 34′″, such that the pivoting of the pawl 80′″ disengages the pawl from the bolt 88′″ to releaseable decouple the pawl 80′″ from the deploy bracket 34′″, in a manner as described herein above. The actuator 100′″ may be configured to engage the locking hook 116′″ before engaging the pawl 80′″ (see sequence of FIGS. 36, 39 and 40). The actuator 100′″ may be configured to drive the hood bracket 32′″ relative to the body bracket 30′″ in a vertical direction 777 and horizontal direction 888 to the deployed position (see FIG. 41) subsequent to the actuator 100′″ pivoting the locking hook 116′″ into engagement with the engagement feature 120′″. As a result the hood 12′″ may avoid contact with the vehicle body 11 during an active pedestrian protection operation of the active hood hinge 14′″, as shown in FIG. 41.

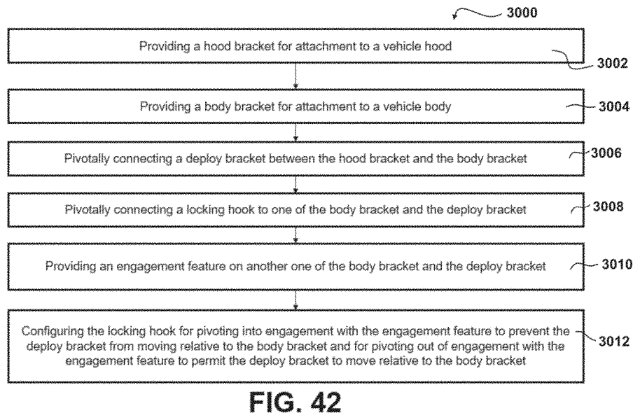

Now referring to FIG. 42, in addition to the other Figures referred to herein, there is illustrated a method 3000 for assembling an active hinge, the method 3000 the steps of providing a hood bracket for attachment to a vehicle hood 3002, providing a body bracket for attachment to a vehicle body 3004, pivotally connecting a deploy bracket between the hood bracket and the body bracket 3006, pivotally connecting a locking hook to one of the body bracket and the deploy bracket 3008, providing an engagement feature on another one of the body bracket and the deploy bracket 3010, and configuring the locking hook for pivoting into engagement with the engagement feature to prevent the deploy bracket from moving relative to the body bracket and for pivoting out of engagement with the engagement feature to permit the deploy bracket to move relative to the body bracket 3012. The method further include providing an actuator for selectively pivoting the locking hook into engagement with the engagement feature. The method may further include pivotally connecting a pawl to the hood bracket, wherein the pawl defines a pocket, engaging the pawl with the deploy bracket to prevent the hood bracket to move from a non-deployed position to a deployed position, and configuring the pawl to disengage from the deploy bracket using the actuator to allow the hood bracket to move from the non-deployed position to the deployed position. The method 3000 may further include the step of configuring the actuator to engage the locking hook before engaging the pawl. The method 3000 may further include forming the engagement feature as a projecting tab with the one of the deploy bracket and the body bracket. The method 3000 may further include providing the engagement feature on the deploy bracket and pivotally mounting the locking hook to the body bracket. The method 3000 may further include pivotally mounting the deploy bracket to the body bracket about a pivot point. The method 3000 may further include coupling the hood bracket to the deploy bracket using at least one link, wherein the pivot point of the deploy bracket relative to the body bracket is offset from the pivot point of the hood bracket relative to the deploy bracket. The method 3000 may further include providing the lock hook with a recessed notch for receiving the engagement feature when the engagement feature is engaged with the locking hook.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in that particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or later, or intervening element or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to described various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. An active hinge comprising:
a hood bracket for attachment to a vehicle hood;
a body bracket for attachment to a vehicle body;
a deploy bracket pivotally attached between the hood bracket and the body bracket, the hood bracket being moveable relative to the body bracket between a non-deployed position and a deployed position;
a locking hook pivotally mounted to one of the body bracket and the deploy bracket, and an engagement feature for engagement by the locking hook, the engagement feature provided on another one of the body bracket and the deploy bracket; and
an actuator for selectively pivoting the locking hook for engaging the locking hook with the engagement feature to prevent the deploy bracket from moving relative to the body bracket and for moving the hood bracket from the non-deployed position to the deployed position.

2. The active hinge as set forth in claim 1, wherein the engagement feature is provided on the deploy bracket and the locking hook is pivotally mounted to the body bracket.

3. The active hinge as set forth in claim 2, wherein the deploy bracket is pivotally mounted to the body bracket.

4. The active hinge as set forth in claim 3, further comprising at least one link pivotally coupling the hood bracket to the deploy bracket, wherein a pivot point of the deploy bracket relative to the body bracket is offset from the pivot point of the hood bracket relative to the deploy bracket.

5. The active hinge as set forth in claim 4, wherein as the hood bracket is moved from the non-deployed position to the deployed position, a path of travel of the hood bracket when the locking hook is in engagement with the engagement feature is different from a path of travel of the hood bracket when the locking hook is in disengagement from the engagement feature

6. The active hinge as set forth in claim 1, wherein the locking hook includes a recessed notch for receiving the engagement feature when the engagement feature is engaged with the locking hook.

7. The active hinge as set forth in claim 6, wherein the engagement feature is a projecting tab formed with the deploy bracket.

8. The active hinge as set forth in claim 1, further comprising:
a pawl pivotally mounted to the hood bracket for releasable coupling to the deploy bracket; and
the actuator for selectively pivoting the pawl for disengaging the pawl from the deploy bracket, to allow the hood bracket to move from the non-deployed position to the deployed position in response to engagement of the actuator with the hood bracket.

9. The active hinge as set forth in claim 8, further comprising:
a bolt for engagement by the pawl, the bolt connected the deploy bracket,
wherein the pivoting of the pawl disengages the pawl from the bolt to releaseable decouple the pawl from the deploy bracket.

10. The active hinge as set forth in claim 8, wherein the actuator is configured to engage the locking hook before engaging the pawl.

11. The active hinge as set forth in claim 1, wherein the actuator is configured to drive the hood bracket relative to the body bracket in a vertical and horizontal direction to the deployed position subsequent to the actuator pivoting the locking hook into engagement with the engagement feature.

12. A method for assembling an active hinge, the method comprising:
providing a hood bracket for attachment to a vehicle hood;
providing a body bracket for attachment to a vehicle body;
pivotally connecting a deploy bracket between the hood bracket and the body bracket;
pivotally connecting a locking hook to one of the body bracket and the deploy bracket;
providing an engagement feature on another one of the body bracket and the deploy bracket; and
configuring the locking hook for pivoting into engagement with the engagement feature to prevent the deploy bracket from moving relative to the body bracket and for pivoting out of engagement with the engagement feature to permit the deploy bracket to move relative to the body bracket.

13. The method for assembling an active hinge of claim 12, the method further comprising providing an actuator for selectively pivoting the locking hook into engagement with the engagement feature.

14. The method for assembling an active hinge of claim 13, the method further comprising:
pivotally connecting a pawl to the hood bracket, wherein the pawl defines a pocket;
engaging the pawl with the deploy bracket to prevent the hood bracket to move from a non-deployed position to a deployed position;
configuring the pawl to disengage from the deploy bracket using the actuator to allow the hood bracket to move from the non-deployed position to the deployed position.

15. The method for assembling an active hinge of claim 14, further including the step of configuring the actuator to engage the locking hook before engaging the pawl.

16. The method for assembling an active hinge of claim 12, further including forming the engagement feature as a projecting tab with the one of the deploy bracket and the body bracket.

17. The method for assembling an active hinge of claim 12, further including providing the engagement feature on the deploy bracket and pivotally mounting the locking hook to the body bracket.

18. The method for assembling an active hinge of claim 17, further comprising pivotally mounting the deploy bracket to the body bracket about a pivot point.

19. The method for assembling an active hinge of claim 18, further comprising coupling the hood bracket to the deploy bracket using at least one link, wherein the pivot point of the deploy bracket relative to the body bracket is offset from the pivot point of the hood bracket relative to the deploy bracket.

20. The active hinge as set forth in claim 12, further comprising providing the lock hook with a recessed notch for receiving the engagement feature when the engagement feature is engaged with the locking hook.
